(19) United States
(12) Patent Application Publication
(10) Pub. No.: US 2005/0177611 A1
(43) Pub. Date: Aug. 11, 2005

(54) Addition circuit

(76) Inventors: Kaoru Awaka, Ibaraki (JP); Akihiro Takegama, Ibaraki (JP); Yutaka Toyonoh, Ibaraki (JP); Shigetoshi Muramatsu, Chiba (JP)

Correspondence Address: TEXAS INSTRUMENTS INCORPORATED, P O BOX 655474, M/S 3999, DALLAS, TX, 75265, US

(21) Appl. No.: 11/013,118

(22) Filed: Dec. 14, 2004

(30) Foreign Application Priority Data
Dec. 18, 2003 (JP) 2003-420,513

(51) Int. Cl. G06F 7/50

(52) U.S. Cl. 708/706

(57) ABSTRACT

The objective of this invention is to provide a type of addition circuit that can perform addition at a high speed without increasing power consumption, as well as a type of multiplication circuit and a type of multiplication/addition circuit having said addition circuit as the last step. It has a characteristic feature that the delay in a signal input from a Wallace tree to the addition circuit in the last step is maximum in the intermediate bit range, and it is smaller in the lower and upper bit ranges. In the lower bit range, addition is performed by means of 1-level carry increment adder 1 with a larger delay in carry propagation to the upper place. In the intermediate bit range, addition is performed by means of 2-level carry increment adder 1 having a carry propagation speed higher than that in said lower bit range. In the upper bit range, addition is performed by means of high-speed carry select adder 3. In this way, because addition is performed using addition schemes matched to the trend of delay in the signal input timing in the various bit ranges, it is possible to perform computing at high speed while the circuit scale and power consumption are reduced.

### CROSS REFERENCE TO RELATED APPLICATIONS

This application claims priority under 35 USC §119 of Japanese Application Serial No. 2003-420,513, filed Dec. 18, 2003.

### FIELD OF THE INVENTION

This invention pertains to a type of addition circuit. Especially, this invention pertains to a type of addition circuit for use in the last step of a multiplication circuit or a multiplication/addition circuit.

### BACKGROUND OF THE INVENTION

Usually, just as in the case of the hand multiplication shown in FIG. 16, a multiplication circuit has a constitution in which the partial products of the various bits of the multiplier and the multiplicand are first computed, and these partial products are added to get the multiplication result.

In the addition circuit of the partial products, in order to suppress delay in propagation of the carry signal as the number of steps of adders is increased, a so-called Wallace tree addition circuit is used. The Wallace tree is a circuit having a constitution in which full adders are connected in a tree configuration. As shown in FIG. 16, it has the function that plural partial products finally are wrapped up into two signals. For the Wallace tree, propagation of the carry signal in company with addition is performed only partially, so that propagation delay of the carry signal can be suppressed.

The multiplication result is obtained by performing addition of the two signals output from the Wallace tree in the addition circuit of the last step. Because propagation of the carry signal left in the Wallace tree is executed by means of addition of said last step, the addition circuit of the last step should have the ability to propagate the carry signal at high speed.

For example, as the addition circuit of the last step of said multiplication circuit, the following circuits are used.

(1) Ripple Carry Adder

The ripple carry adder is a circuit that performs addition of the various places of the input signals by means of full adders. When the carry signal output from the lower full adder is sequentially propagated to the upper full adders, a sum output is obtained. Because the carry signal is propagated 1 bit at a time, the carrying speed is low. This is a disadvantage. However, the circuit configuration is simpler and the power consumption is lower than that of the addition circuits to be explained below. These are advantages.

(2) Carry Look Ahead Adder

The carry look ahead adder is an addition circuit that performs generation of the carry signal at high speed by generating a portion of the carry signal of the upper place by means of a carry look ahead circuit. For example, by using the carry look ahead circuit in the ripple carry adder, it is possible to alleviate the propagation delay in the carry signal.

FIG. 17 is a block diagram illustrating an example of the constitution of a 4-place carry look ahead adder.

In FIG. 17, full adders 201-204 are circuits for performing addition of the 0^{th} to 3^{rd} places of the input signals. The circuit composed of AND circuits 205-209 and selector 210 is the carry look ahead circuit that generates the 3^{rd} place carry signal c3.

Full adders 201, . . . 204 have the 0^{th} place bit signals (a0, b0), . . . and the 3^{rd} place signals (a3, b3) input to them, respectively, and, at the same time, they have carry signals CIN, c0, c1, c2 input to them, respectively, and they output sum signals s0, . . . s3 and carry signals c0, . . . c3, respectively. The carry signals c0, c1, c2 output from full adders 201, 202, 203 are input to their upper place full adders 202, 203, 204, respectively.

In the process of computing the sum signal and carry signal, full adders 201, . . . 204 generate carry propagation signals p0, . . . , p3 and carry generation signals g0, . . . g3, respectively. Carry propagation signals p0, . . . p3 are exclusive OR of the bit signals of the places and carry generation signals g0, . . . g3 are AND of the bit signals of the places.

Carry look ahead circuit generates 3^{rd} carry signal c3 based on said carry propagation signals p0, . . . p3 and carry propagation signals p0, . . . p3.

That is, 4-input AND circuit 205 computes the AND of carry propagation signals p3, p2, p1 and carry generation signal g0; 3-input AND circuit 206 computes the AND of carry propagation signals p3, p2 and carry generation signal g1; and 2-input AND circuit 208 computes the AND of carry propagation signal p3 and carry generation signal g2. 4-input OR circuit 208 computes the OR of said three ANDs and carry generation signal g3. Selector 210 outputs OR of 4-input OR circuit 208 when the result of computing the AND of carry propagation signals p0, . . . p3 in 4-input AND circuit 209 is “0”, and it outputs carry signal CIN when the AND of 4-input AND circuit 209 is “1”. The output signal of said selector 210 is used as carry signal c3 in computing the upper place.

For the carry look ahead adder, because computing of the carry signal is performed with plural circuits set in parallel, generation of the carry signal can be performed at high speed. However, the circuit scale and power consumption are increased, and this is undesired.

(3) Carry Select Adder

The carry select adder is a circuit that performs the following operation: it pre-computes the addition results in two cases, namely, when the carry signal from the lower place is “0” and when it is “1”, and, when the carry signal arrives, it selects one of the two addition results by means of a selector, and outputs the result. For example, said ripple carry adder may be used as the addition circuit for each place.

When the carry signal from the lower place is delayed with respect to the input signal, especially, when the prediction values of the addition results of the various places are obtained before arrival of the carry signal, it is possible to output the addition result from the selector upon arrival of the carry signal. Consequently, the carry select adder works at high speed. However, because it contains a circuit that performs two rounds of addition operation, the circuit scale and power consumption increase, and this is undesired.

(4) Carry Select Adder+Carry Look Ahead Adder

FIG. 18 is a diagram illustrating a type of addition circuit in which while the sum output of all bits is computed with carry select adders 211-213, carry signal (c31) of the upper place is generated with carry look ahead circuit 214. In this way, by means of a combination of carry select adders and a carry look ahead adder, it is possible to generate both a sum signal and a carry signal at high speed. However, because the carry look ahead circuit is required as an excessive portion, the circuit scale and power consumption increase.

(5) 1-Level Carry Increment Adder

The carry increment adder has circuits that generate localized carry generation signals and carry propagation signals sequentially from the lower place to the upper place, respectively. When a carry signal arrives from a lower place, said localized carry generation signal and carry propagation signal are used to compute the carry signal and sum signal of each place. The 1-level carry increment adder has one level of circuits for generating said localized carry generation signals and carry propagation signals.

Although generation of the sum output of the 1-level carry increment adder is delayed a little with respect to the carry select adder, only 1 series of circuits corresponding to the ripple carry adder is required, so that its circuit scale and power consumption are smaller than those of the carry select adder.

(6) 2-Level Carry Increment Adder

For said 1-level carry increment adder, if the bit length for addition increases, generation of the localized carry generation signal and carry propagation signal may become delayed with respect to arrival of the carry signal from the lower place. In order to overcome this disadvantage, the 2-level carry increment adder has two levels of circuits for generating the localized carry generation signal and carry propagation signal. Consequently, as generation of said localized signals is carried out in parallel, said delay can be suppressed.

FIG. 19 compares the conventional addition circuits with respect to properties, that is, speed, power consumption, and circuit area. In FIG. 19, “O” indicates excellent, “X” indicates poor, and “Δ” indicates intermediate.

As can be seen from FIG. 19, for conventional addition circuits, when efforts are made to increase the speed, the power consumption and circuit area increase, and it is difficult to obtain good results for both of them. This is undesired.

The objective of this invention is to solve the aforementioned problems of conventional methods by providing a type of addition circuit that can perform an addition operation without increasing the power consumption. This invention also provides a type of multiplication circuit having said addition circuit in it.

### SUMMARY OF THE INVENTION

In order to realize the aforementioned objective, the first invention of this patent application provides a type of addition circuit characterized by the following facts: it has plural addition units that perform addition of different bit ranges of input signals of addition objects, and at least two of said plural addition units perform addition by means of different addition schemes, which match the trend of change in the input timing of the bit signals of the addition objects in the bit range where addition is performed in company with shift to the upper place, with the difference in the trend of change of the computing timing of the addition value of each place in company with shift to the upper place.

For said addition circuit, the following constitution is preferred: said plural addition units include a first addition unit that performs addition by means of a first addition scheme, which has said addition value computing timing delayed in company with shift to the upper place for the input signal in a first bit range having a trend that the input timing of the bit signal is delayed in company with shift to the upper place, and a second addition unit that performs addition by means of a second addition scheme, which has said addition value computing timing delayed less than that of said first addition scheme in company with shift to the upper place for the input signal in a second bit range having a trend of delay of said input timing more or less than that in said first bit range.

Said first addition unit and said second addition unit each contain a first carry propagation signal generating circuit which has plural circuits connected in tandem and, based on carry propagation signal p(i−1, K) from the former step, generates carry propagation signal p(i, K) that indicates whether the carry signal generated at the ith place changes corresponding to the carry signal to the Kth place (where, K is a positive integer, and i is an integer, with i>K), a first carry generation signal generating circuit, which has plural circuits connected in tandem and, based on carry generation signal g(i−1, K) from the former step, generates carry generation signal g(i, K) that indicates whether the carry signal generated at ith place becomes a prescribed bit value independent of the carry signal to the Kth place, and a carry signal generating circuit, which generates the carry signal generated at the ith place based on carry propagation signal p(i, K) output from said first carry propagation signal generating circuit, carry generation signal p(i, K) output from said first carry generation from signal generating circuit, and the carry signal to the Kth place.

Also, the kth carry propagation signal generating circuit (where k is an integer of 2 or larger) is a circuit containing plural circuits connected in tandem and generating carry propagation signal p(M2, M0) based on carry propagation signal p(M2, M1) (where, M2 and M1 are positive integers with M2>M1) output from the last step of the tandem circuit of the (k−1)th carry propagation signal generating circuit, and carry propagation signal p(M1−1, M0) (where, M0 is a positive integer, with M1>M0) from the former step; the kth carry generation signal generating circuit is a circuit containing plural circuits connected in tandem and generating carry generation signal g(M2, M0) based on carry generation signal g(M2, M1) output from the last step of the tandem circuit of the (k−1)th carry generation signal generating circuit and carry generation signal g(M1−1, M0) from the former step.

In this case, said first addition unit contains a kth carry propagation signal generating circuit and a kth carry generation signal generating circuit with k up to m (where m is an integer of 1 or larger); said second addition unit contains a kth carry propagation signal generating circuit and a kth carry generation signal generating circuit with k up to n (where n is an integer larger than m).

Also, said plural addition units each have a third addition unit, which, with respect to the input signal of the bit range having a trend of advance of said input timing in company with shift to the upper place, pre-computes prediction values of the carry signals of the various places corresponding to the assumed values of the carry signals from the lower places fed to said bit range, respectively, and which performs addition using a third addition scheme that generates the carry signals of the various places based on the carry signals fed from said lower places and said predicted values.

In addition, said plural addition units each have a fourth addition unit, which performs addition using a fourth addition scheme that sequentially computes the carry signals from the lower place to the upper place with respect to the input signal of the bit range having a trend of delay of said input timing in company with shift to the upper place.

In order to realize the aforementioned objective, the second invention of this patent application provides a type of multiplication circuit characterized by the fact that the multiplication circuit has a first addition circuit that outputs two signals as the result of addition of more than two plural partial products, and a second addition circuit that adds the two signals output from said first addition circuit; and said second addition circuit is the addition circuit described in the first invention of this patent and having plural addition units that perform addition of the different bit ranges of the two signals output from said first addition circuit, respectively.

Said second addition circuit may contain said first addition unit that performs addition of said two signals for the bit range from the least significant place to a prescribed intermediate place, said second addition unit that performs addition of said two signals for the bit range from said intermediate place to a prescribed upper place, and said third addition unit that performs addition of said two signals for the bit range from said upper place to the most significant place.

Also, said second addition circuit may output the bit signal of the least significant place of one of said two signals as the result of addition of the least significant place, and, at the same time, it outputs an exclusive OR of the bit signals of the upper place as the result of addition of the upper place of said least significant place.

In addition, said second addition circuit may output a NOT signal of the carry signal from the lower place to the most significant place as the result of addition of the most significant place.

This multiplication circuit may also be formed as a multiplication addition circuit.

### BRIEF DESCRIPTION OF THE DRAWINGS

FIG. 1 is a block diagram illustrating an example of the constitution of a multiplication circuit in an embodiment of this invention.

FIG. 2 is a diagram illustrating an example of output delay of a Wallace tree having a 40-bit signal output.

FIG. 3 is a block diagram illustrating an example of the constitution of a second addition circuit in an embodiment of this invention.

FIG. 4 is a block diagram illustrating an example of the constitution of a 1-level carry increment adder in the second addition circuit shown in FIG. 3.

FIG. 5 is a first block diagram illustrating an example of the constitution of a 2-level carry increment adder in the second addition circuit shown in FIG. 3.

FIG. 6 is a second block diagram illustrating an example of the constitution of a 2-level carry increment adder in the second addition circuit shown in FIG. 3.

FIG. 7 is a block diagram illustrating the connection relationship of the portion pertaining to generation of a localized carry propagation signal and carry generation signal in the carry increment adder shown in FIG. 6.

FIG. 8 is a block diagram illustrating the connection relationship of the portion pertaining to generation of a carry signal in the carry increment adder shown in FIG. 6.

FIG. 9 is a block diagram illustrating an example of the constitution of a carry select adder in the second addition circuit shown in FIG. 3.

FIG. 10 is a block diagram illustrating an example of the constitution of a full adder.

FIG. 11 is a block diagram illustrating an example of a second addition circuit pertaining to the second embodiment of this invention.

FIG. 12 is a block diagram illustrating an example of the constitution of a second addition circuit pertaining to the third embodiment of this invention.

FIG. 13 is a block diagram illustrating an example of the constitution of a ripple carry adder in the second addition circuit shown in FIG. 12.

FIG. 14 is a block diagram illustrating an example of the constitution of second addition circuit 102 pertaining to the fourth embodiment of this invention.

FIG. 15 is a block diagram illustrating an example of the constitution of second addition circuit 102 pertaining to the fifth embodiment of this invention.

FIG. 16 is a diagram illustrating the process of multiplication in a conventional case.

FIG. 17 is a block diagram illustrating an example of the constitution of a 4-place carry look ahead adder.

FIG. 18 is a diagram illustrating an addition circuit in which the sum output of all bits is computed by means of a carry select adder, and, at the same time, the carry signal of the upper place is generated by means of a carry look ahead circuit.

FIG. 19 is a diagram comparing the performance of conventional addition circuits with respect to the speed, power consumption, and circuit area.

### REFERENCE NUMERALS AND SYMBOLS AS SHOWN IN THE DRAWINGS

In the figures, 1, 2, 4, 5, 7, 8 represent a carry increment adder (CIA); 3 represents a carry select adder (CSA); 6, 9 represent a ripple carry adder (RCA); 10, 11 represent an addition unit; 10_1-10_15, 14_0-14_15, 22_0-22_3, 23_0-23_9, 26_0-26_14, 35 represent an AND circuit; 11_0-11_15, 12_1 -12_15, 20_0-20_3, 21_0-21_9, 24_0-24_14, 34 represent an AND-OR composite circuit; 13_0-13_15, 15_0-15_15, 25_0-25_14, 27_0-27_14, 33, 36 represent an exclusive OR circuit; 30_0-30_8, 31_0-31_8, 60_0-60_15 represent a full adder; 32_0-32_8 represent a selector; 100 represents a partial product generating circuit; 101 represents a first addition circuit; and 102 represents a second addition circuit.

### DETAILED DESCRIPTION OF THE DRAWINGS

With the addition circuit of this invention, it is possible to perform an addition operation at high speed with reduced circuit scale and power consumption.

Also, with the multiplication circuit or multiplication addition circuit of this invention, it is possible to perform a multiplication operation at high speed with reduced circuit scale and power consumption.

In the following, five embodiments of this invention will be explained with reference to figures.

Embodiment 1

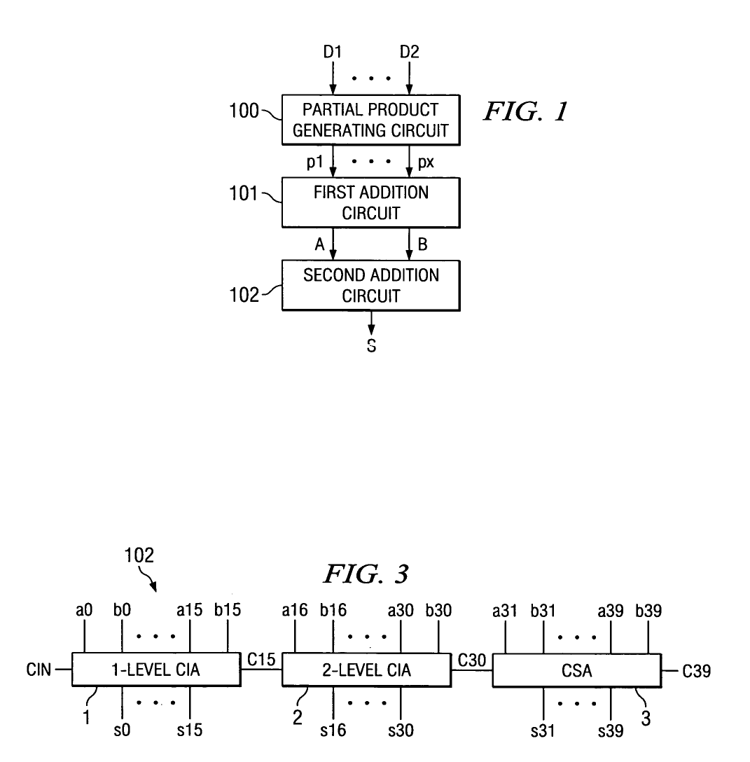

FIG. 1 is a block diagram illustrating an example of the constitution of the multiplication circuit in Embodiment 1 of this invention.

The multiplication circuit shown as an example in FIG. 1 has partial product generating circuit 100, first addition circuit 101, and second addition circuit 102.

Said first addition circuit 101 is an embodiment of the first addition circuit of this invention.

Said second addition unit 102 is an embodiment of the second addition circuit of this invention.

For partial product generating circuit 100, signals D1 and D2 of a multiplier and multiplicand are input, and more than two plural partial products p1-px are generated. For example, partial product generating circuit 100 uses Booth encoding or another method to generate said partial products.

First addition circuit 101 outputs two signals A and B as the result of addition of the plural partial products p1-pX output from partial product generating circuit 100. For example, first addition circuit 101 may have a constitution in which full adders are connected in a Wallace tree configuration, and it has the same constitution as that of an addition circuit of partial products in other parallel type multipliers.

Second addition circuit 102 adds signals A and B output from first addition circuit 101, and it outputs addition result S.

Assuming that multiplicand has L bits, and the multiplier has M bits, said partial product generating circuit 100 generates M partial products. Said first addition circuit 101 performs addition until said M partial products finally become two signals A and B. For example, when addition is performed with the aid of a Wallace tree, because propagation of the carry signal is not fully performed, the place having the greatest delay in the output of first addition circuit 101 is a place in the central portion where there are many addition steps (see FIG. 16), instead of the most significant place. This characteristic feature is not limited to the case of addition by means of a Wallace tree; the same is true for addition circuits of partial products in the other parallel type multipliers using full adders, etc.

FIG. 2 is a diagram illustrating an example of the delay in output of a Wallace tree having a 40-bit signal output. In this figure, the abscissa represents the place number from the 0^{th} to the 39^{th} place, and the ordinate represents the delay time in the output signal. As shown in the figure, in the lower-side bit range, the delay increases as the place shifts to the upper place. The delay reaches a maximum and stays nearly constant in the central bit range. In the upper-side bit range, the delay tends to decrease as the place moves to the upper place.

Matched to said trend of delay in the output signal of the former-step circuit, second addition circuit 102 performs an addition operation with different addition schemes for the lower, intermediate, and upper bit ranges, respectively.

That is, for input signals in the lower bit range where there is a trend of delay of said input timing of the bit signal in company with shift to the upper place, addition is performed with a first addition scheme in which the computing timing of the addition value is delayed as the place moves to the upper place.

For input signals in the intermediate bit range where there is a trend of a mild delay or advance in the input timing of the bit signal compared with said lower bit range in company with shift to the upper place, addition is performed with a second addition scheme in which the computing timing of the addition value is delayed less than in said first addition scheme in company with shift to the upper place.

For input signals in the upper bit range where there is a trend of advance of said input timing of the bit signal in company with shift to the upper place in company with shift to the upper place, addition is performed with a third addition scheme in which the operation is performed as follow: first, predicted values of the carry signals and sum signals of the various places are pre-computed corresponding to the case when the carry signal fed from said intermediate bit range is “0” and when it is “1”, respectively, and, based on said carry signals and predicted values, carry signals and sum signals of the various places are generated.

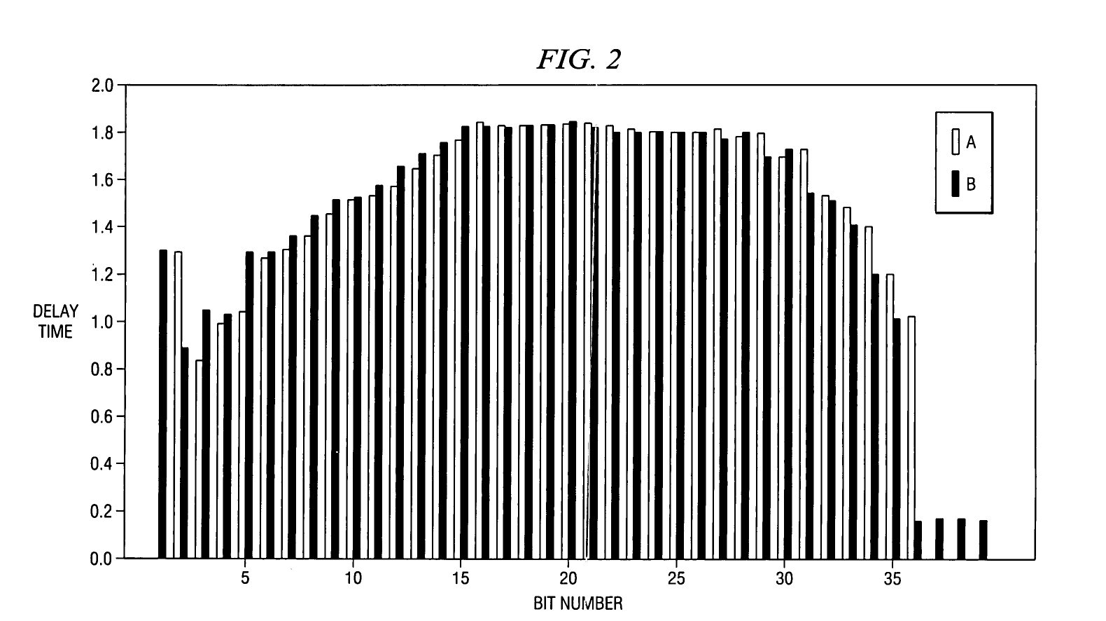

In the following, the detailed constitution of second addition circuit 102 will be explained with reference to FIGS. 3-10.

In the following, as an example, it is assumed that each of input signals A and B input as addition objects to first addition circuit 101 and sum signal S output from first addition circuit 101 has 40 bits.

The following symbols are adopted to represent the various signals.

For input signal A, input signal B, and sum signal S, the bit signals of the 0^{th} to 39^{th} places are represented as “a0”-“a39”, “b0”-“b39”, and “s0”-“s39”, respectively.

The carry signals generated in the 0^{th} to 39^{th} places are represented as “c0”-“c39”, respectively.

The carry signal fed to the 0^{th} place is represented as “CIN”.

The carry propagation signal of the jth place corresponding to the exclusive OR of bit signals aj and bj of the jth place (where, j represents an integer of 0-39) is represented as “pj”.

The carry generation signal of the jth place corresponding to the AND of bit signals aj and bj of the jth place (as above, j represents an integer of 0-39) is represented as “gj”.

In addition, the following signals are defined.

Carry propagation signal pi_K is a signal indicating whether there is a change in the carry signal ci generated in ith place (i is an integer with i>K) corresponding to carry signal c(K−1) to the Kth place (K is a positive integer).

Carry generation signal gi_K is a signal indicating whether the carry signal ci generated in the ith place and independent of carry signal c(K−1) to the Kth place is “1”.

Carry propagation signal pi_K and carry generation signal gi_K are represented by the following equations, respectively.

$$\begin{matrix}Mathematical Formula 1 & \\ pi\_k = p i \times p ( i - 1 ) \times ⋯ p k & ( 1 ) \\ gi\_k = p i \times p ( i - 1 ) \times ⋯ \times p ( k + 1 ) \times g k + & ( 2 ) \\ p i \times p ( i - 1 ) \times ⋯ \times p ( k + 2 ) \times g ( k + 1 ) & \\ ⋮ + & \\ p i \times g ( i - 1 ) + & \\ g i & \end{matrix}$$

Also, when i=K, carry propagation signal pi_K is taken as equal to carry propagation signal pi, and carry generation signal gi_K is taken as equal to carry generation signal gi.

As can be seen from Equation 1, when carry propagation signal pi_K is “1”, for all of input bit signals (aK, bK), . . . (ai, bi), one is “1”, and the other is “0”. Consequently, when carry signal c(K−1) becomes “1”, carry signal ci becomes “1”, and when carry signal c(K−1) becomes “0”, carry signal ci becomes “0”. That is, carry signal ci changes corresponding to carry signal c(K−1). On the other hand, when carry propagation signal pi_K is “0”, input bit signals (aj, bj) exist wherein both are “0” or both are “1” (where, j is an integer from K to i). Consequently, change of carry signal c(K−1) cannot exceed this bit and propagate to the ith place.

Also, as can be seen from Equation 2, when carry generation signal gi_K is “1”, at least one place exists where both input bit signals (aj, bj) are “1”, and for each of the bit signals of the various places from this place to the ith place, at least one is “1”. Consequently, in this case, no matter what value carry signal c(K−1) is, carry signal ci becomes “1”. On the other hand, when carry generation signal gi_K is “0”, either carry signal ci is “0” for any value of carry signal c(K−1), or carry signal ci changes corresponding to carry signal c(K−1) (that is, pi_K=“1”).

FIG. 3 is a block diagram illustrating an example of the constitution of second addition circuit 102.

For example, as shown in FIG. 3, second addition circuit 102 has 1-level carry increment adder 1 that performs addition for the lower bit range from the 0^{th} place to the 15^{th} place, 2-level carry increment adder 2 that performs addition for the intermediate bit range from the 16^{th} place to the 30^{th} place, and carry select adder 3 that performs addition for the upper bit range from the 31^{st} place to the 39^{th} place. In the following, a carry increment adder will be represented as CIA, and a carry select adder will be represented as CSA.

CIA1 is an embodiment of the first addition unit of this invention.

CIA2 is an embodiment of the second addition unit of this invention.

CIA3 is an embodiment of the third addition unit of this invention.

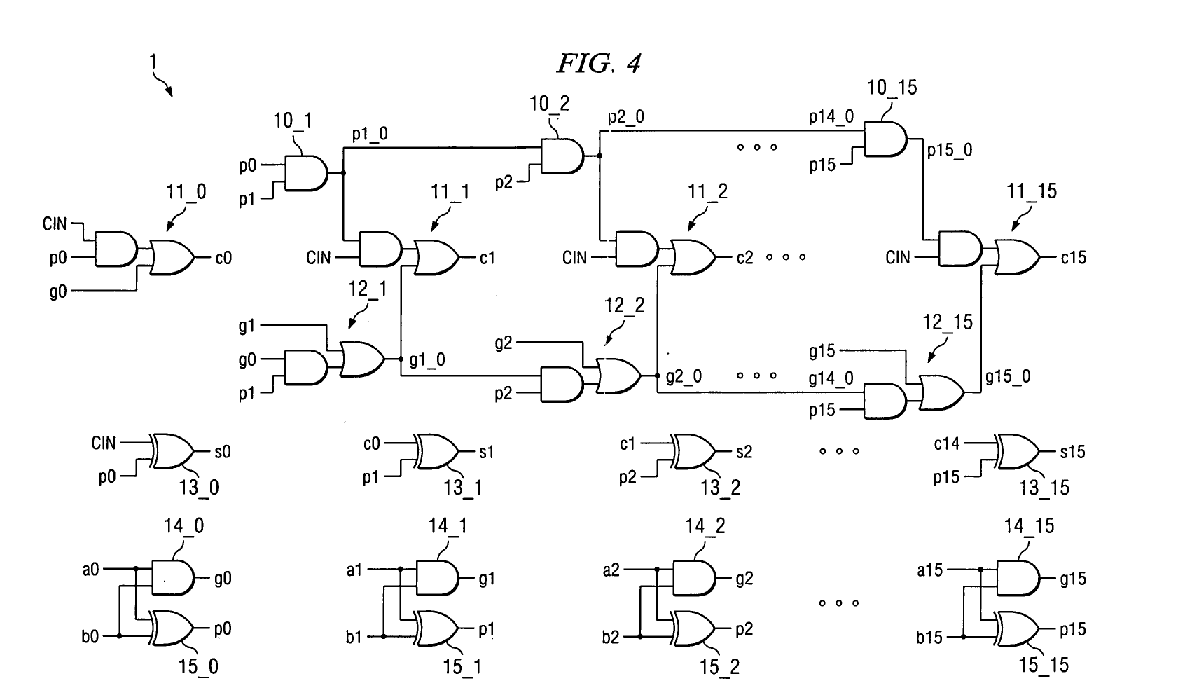

FIG. 4 is a block diagram illustrating an example of the constitution of CIA1.

For example, as shown in FIG. 4, CIA1 has the following circuits: tandem circuit of AND circuits 10_1, . . . 10_15, tandem circuit of AND-OR composite circuits 12_1 , . . . 12_15, AND-OR composite circuits 11_0, . . . 11_15 that output carry signals c0, . . . . c5, exclusive OR circuits 13_0, . . . 13_15 that output sum signals s0, . . . s15, AND circuits 14_0, . . . 14_15 that output carry generation signals g0, . . . g15, and exclusive OR circuits 15_0, . . . 15_15 that output carry propagation signals p0, . . . p15.

The tandem circuit of AND circuits 10_1, . . . 10_15 is an embodiment of the first carry propagation signal generating circuit.

The tandem circuit of AND-OR composite circuits 12_1, . . . 12_15 is an embodiment of the first carry generation signal generating circuit.

AND-OR composite circuits 11_0, . . . 11_15 are an embodiment of the carry signal generating circuit of this invention.

In the following, the relationship of connection of the various structural elements of CIA1 will be explained with reference to FIG. 4.

AND circuit 10_1 computes the AND of carry propagation signals p0 and p1, and it outputs the computing result as carry propagation signal p1_.

AND circuit 10_j (where, j is an integer of 2-15) computes the AND of carry propagation signal p(j−1)_0 output from the former-step AND circuit 10_(j−1) and carry propagation signal pj, and outputs the computing result as carry propagation signal pj_0.

AND_OR composite circuit 12_1 computes the OR of the AND of carry generation signal g0 and carry propagation signal p1, and carry generation signal g1, and it outputs the computing result as carry generation signal g1_0.

AND-OR composite circuit 12_j (where, j is an integer of 2-15) computes the OR of the AND of carry generation signal g(j−1) output from former-step AND-OR composite circuit 12_(j−1) and carry propagation signal pj, and carry generation signal gj, and outputs the computing result as carry generation signal gj_0.

AND_OR composite circuit 11_0 computes the OR of the AND of carry signal CIN and carry propagation signal p0, and carry generation signal g0, and it outputs the computing result as carry signal c0.

AND-OR composite circuit 11_j (where, j is an integer of 1-15) computes the OR of the AND of carry signal CIN and carry propagation signal pj_0, and carry generating signal gj_0, and outputs the computing result as carry signal cj.

Exclusive OR circuit 13_0 computes the exclusive OR of carry signal CIN and carry propagation signal p0, and outputs the computing result as sum signal s0.

Exclusive OR circuit 13_j (where, j is an integer of 1-15) computes the exclusive OR of carry signal c(j−1) and carry propagation signal pj, and outputs the computing result as sum signal sj.

AND circuit 14_j (where, j is an integer of 0-15) computes the AND of input bit signals aj and bj, and outputs the computing result as carry generation signal gj.

Exclusive OR circuit 15_j (where, j is an integer of 0-15) computes the exclusive OR of input bit signals aj and bj, and outputs the computing result as carry propagation signal pj.

The above is an explanation of the various structural elements of CIA1.

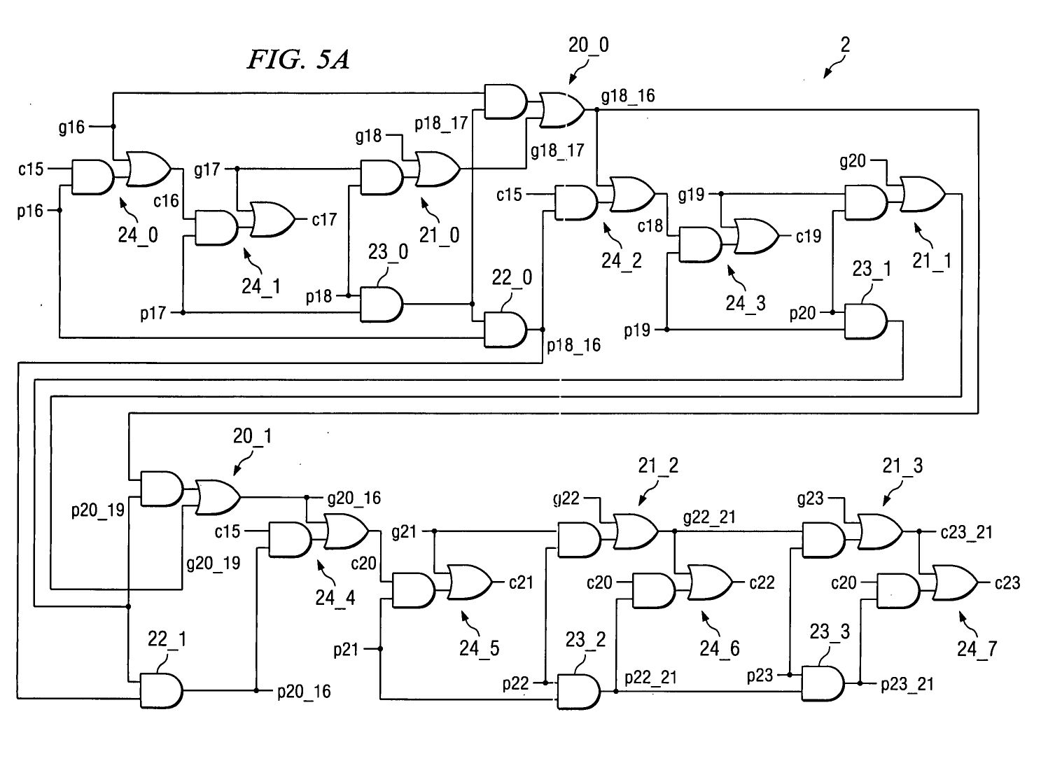

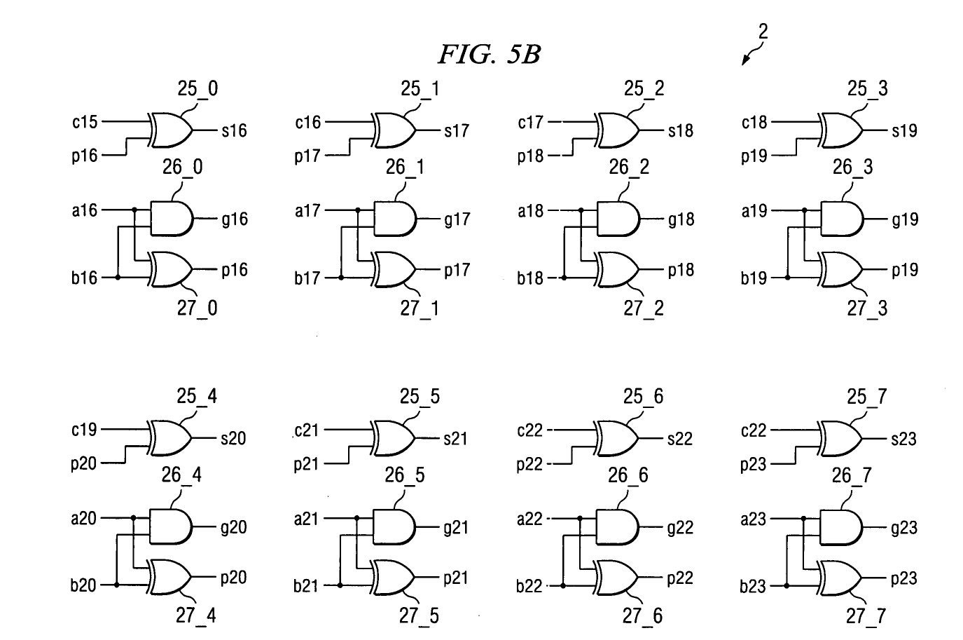

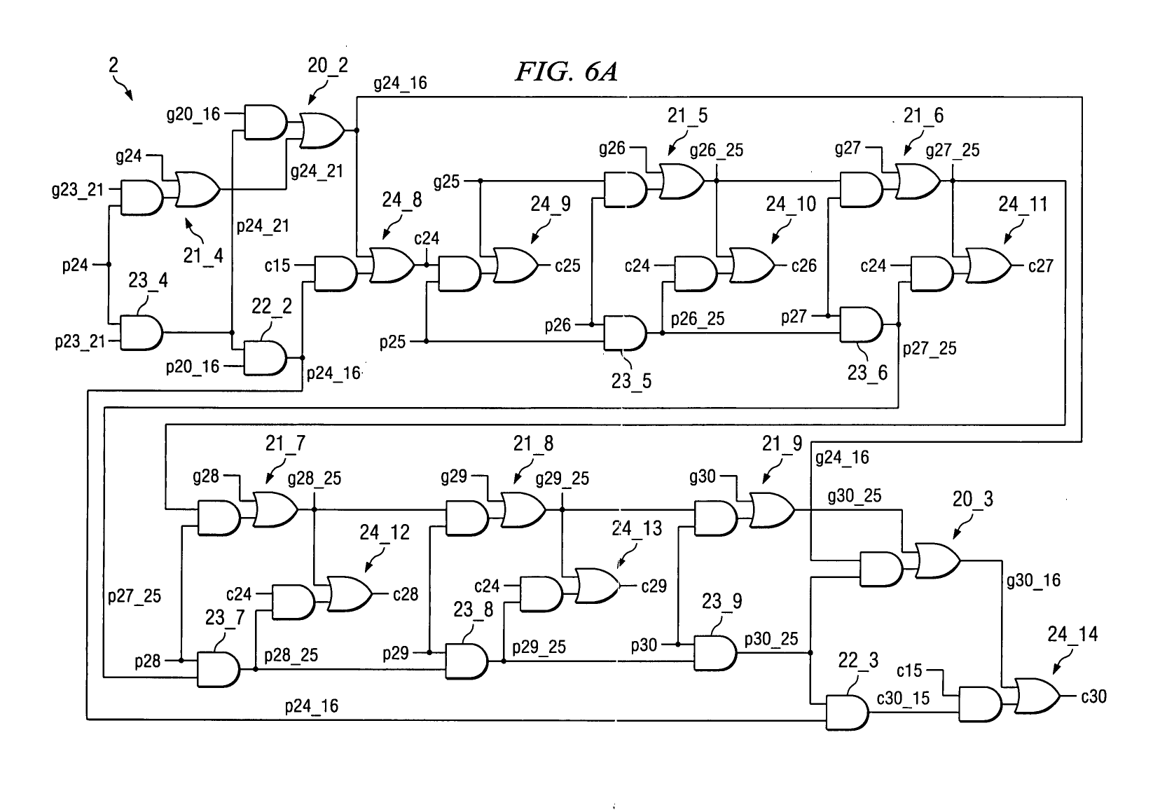

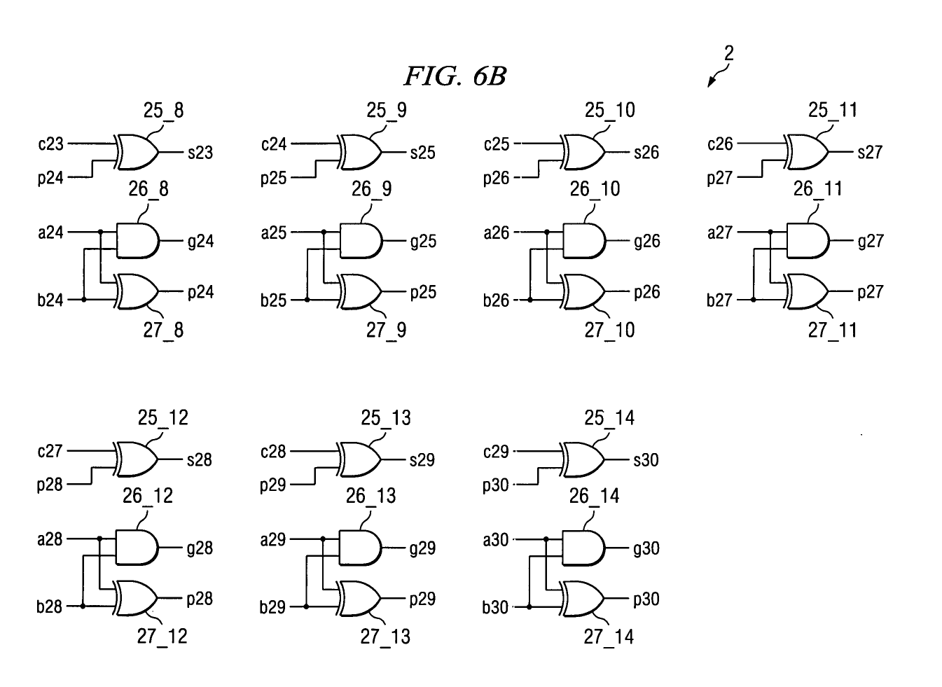

FIGS. 5 and 6 are block diagrams illustrating an example of the constitution of CIA2.

For example, as shown in FIGS. 5 and 6, CIA2 has the following circuits: tandem circuit of AND-OR composite circuits 20_0, . . . 20_3, AND-OR composite circuit 21_0 connected to AND-OR composite circuit 20_0, AND-OR composite circuit 21_1 connected to AND-OR composite circuit 20_1, tandem circuit of AND-OR composite circuits 21_2, . . . 21_4 connected to AND-OR composite circuit 20_2, tandem circuit of AND-OR composite circuits 21_5, . . . 21_9 connected to AND-OR composite circuit 20_3, tandem circuit of AND circuits 22_0, . . . 22_3, AND circuit 23_0 connected to AND circuit 22_0, AND circuit 23_1 connected to AND circuit 22_1, tandem circuit of AND circuits 23_2, . . . 23_4 connected to AND circuit 22_2, tandem circuit of AND circuits 23_5, . . . 23_9 connected to AND circuit 22_3, AND-OR composite circuits 24_0, . . . 24_14 that output carry signals c16, . . . c30, exclusive OR circuits 25_0 . . . 25_14 that output sum signals s16, . . . s30, AND circuits 26_0 . . . 26_14 that output carry generation signals g16, . . . g30, and exclusive OR circuits 27_0, . . . 27_14 that output carry propagation signals p16, . . . p30.

The tandem circuit of AND-OR composite circuits 20_0, . . . 20_3 is an embodiment of the second carry generation signal generating circuit of this invention.

The tandem circuit of AND-OR composite circuit 21_0, AND-OR composite circuit 21_1, AND-OR composite circuits 21_2 . . . 21_4, and the tandem circuit of AND-OR composite circuits 21_5, . . . 21_9 are an embodiment of the first carry generation signal generating circuit of this invention.

The tandem circuit of AND circuits 22_0, . . . 22_3 is an embodiment of the second carry propagation signal generating circuit of this invention.

The tandem circuit of AND circuit 23_0, AND circuit 23_1, AND circuits 23_2 . . . 23_4 and the tandem circuit of AND circuits 23_5, . . . 23_9 are an embodiment of the first carry propagation signal generating circuit of this invention.

AND-OR composite circuits 24_0, . . . 24_14 are an embodiment of the carry signal generating circuit of this invention.

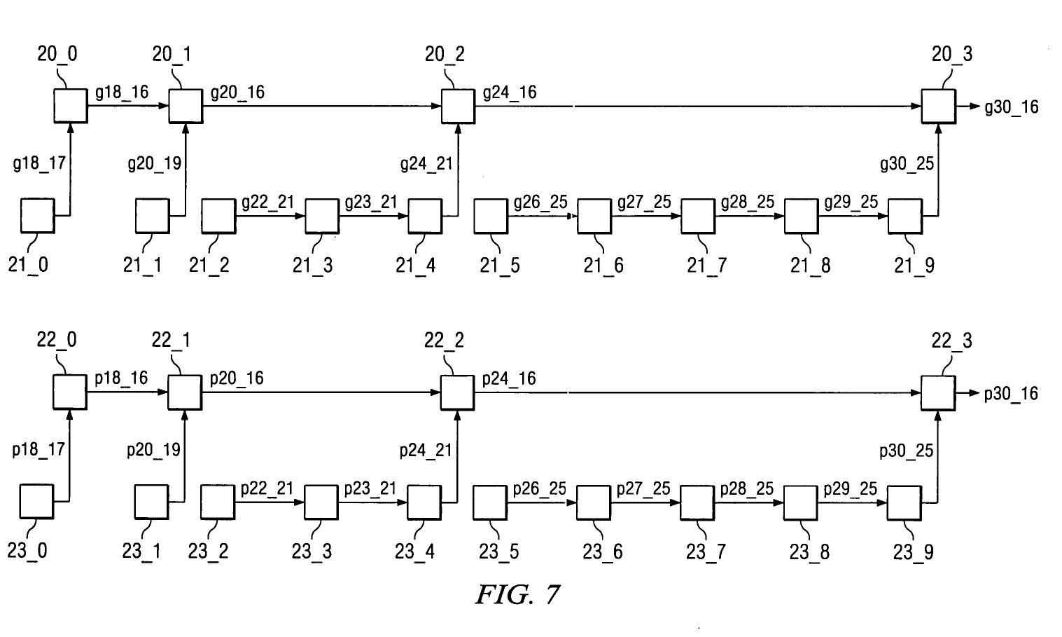

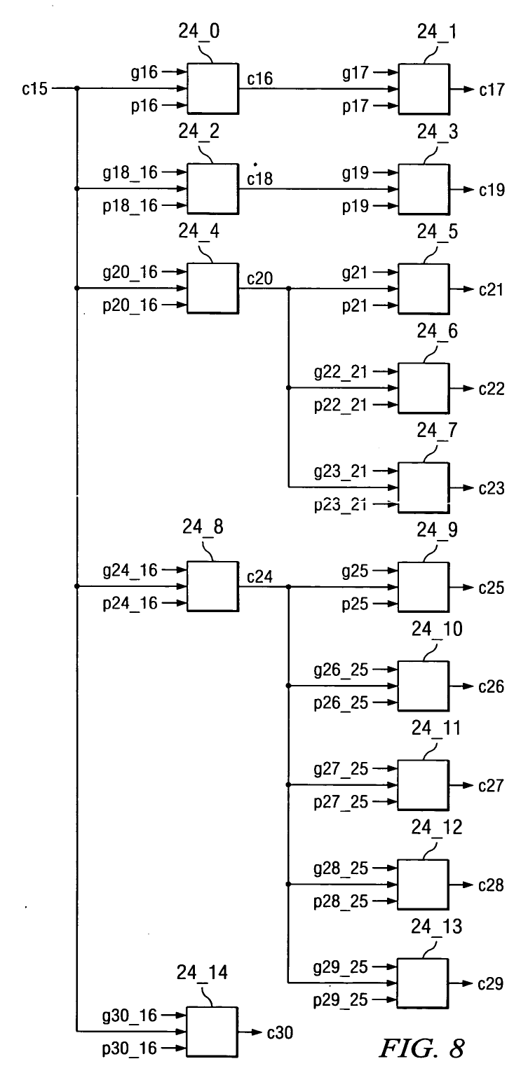

FIG. 7 is a block diagram illustrating the connection relationship of the portion pertaining to generation of the localized carry propagation signal and carry generation signal in CIA2. FIG. 8 is a block diagram illustrating the connection relationship of the portion pertaining to generation of the carry signal in CIA2.

The same part numbers are adopted throughout FIGS. 5-8.

In the following, the connection relationship of the various structural elements of CIA2 will be explained with reference to FIGS. 5-8.

AND circuit 23_0 computes the AND of carry propagation signals p17 and p18, and it outputs the computing result as carry propagation signal p18_17.

AND circuit 22_0 computes the AND of carry propagation signal p16 and carry propagation signal p18_17, and it outputs the computing result as carry propagation signal p18_16.

AND circuit 23_1 computes the AND of carry propagation signals p19 and p20, and it outputs the computing result as carry propagation signal p20_19.

AND circuit 22_1 computes the AND of carry propagation signal p18_16 and carry propagation signal p20_19, and it outputs the computing result as carry propagation signal p20_16.

AND circuit 23_2 computes the AND of carry propagation signals p21 and p22, and it outputs the computing result as carry propagation signal p22_21.

AND circuit 23_j (where j is 3 or 4) computes the AND of carry propagation signal p(20+j) and carry propagation signal p(19+j)_21, and it outputs the computing result as carry propagation signal p(20+j)_21.

AND circuit 22_2 computes the AND of carry propagation signals p20_16 and carry propagation signal p24_21, and it outputs the computing result as carry propagation signal p24_16.

AND circuit 23_5 computes the AND of carry propagation signals p25 and p26, and it outputs the computing result as carry propagation signal p26_25.

AND circuit 23_j (where, j is an integer of 6-9) computes the AND of carry propagation signal p(21+j) and carry propagation signal p(20+j)_25, and it outputs the computing result as carry propagation signal p(21 +j)_25.

AND circuit 22_3 computes the AND of carry propagation signal p30_25 and carry propagation signal p24_16, and it outputs the computing result as carry propagation signal p30_16.

AND-OR composite circuit 21_0 computes the OR of the AND of carry propagation signal p18 and carry generation signal g17, and carry generation signal g18, and it outputs the computing result as carry generation signal g18_17.

AND-OR composite circuit 20_0 computes the OR of the AND of carry propagation signal p18_17 and carry generation signal g16, and carry generation signal g18_17, and it outputs the computing result as carry generation signal g18_16.

AND-OR composite circuit 21_1 computes the OR of the AND of carry propagation signal p20 and carry generation signal g19, and carry generation signal g20, and it outputs the computing result as carry generation signal g20_19.

AND-OR composite circuit 20_1 computes the OR of the AND of carry propagation signal p20_19 and carry generation signal g18_16, and carry generation signal g20_19, and it outputs the computing result as carry generation signal g20_16.

AND-OR composite circuit 21_2 computes the OR of the AND of carry propagation signal p22 and carry generation signal g21, and carry generation signal g22, and it outputs the computing result as carry generation signal g22_21.

AND-OR composite circuit 21_j (where, j is 3 or 4) computes the OR of the AND of carry propagation signal p(20+j) and carry generation signal g(19+j)_21, and carry generation signal g(20+j), and it outputs the computing result as carry generation signal g(20+j)_21.

AND-OR composite circuit 20_2 computes the OR of the AND of carry propagation signal p24_21 and carry generation signal g20_16, and carry generation signal g24_21, and it outputs the computing result as carry generation signal g24_16.

AND-OR composite circuit 21_5 computes the OR of the AND of carry propagation signal p26 and carry generation signal g25, and carry generation signal g26, and it outputs the computing result as carry generation signal g26_25.

AND-OR composite circuit 21_j (where, j is an integer of 6-9) computes the OR of the AND of carry propagation signal p(21 +j) and carry generation signal g(20+j)_25, and carry generation signal g(21+j), and it outputs the computing result as carry generation signal g(21+j)_25.

AND-OR composite circuit 20_3 computes the OR of the AND of carry propagation signal p30_25 and carry generation signal g24_16, and carry generation signal g30_25, and it outputs the computing result as carry generation signal g30_16.

AND-OR composite circuit 24_0 computes the OR of the AND of carry propagation signal p16 and carry signal C15, and carry generation signal g16, and it outputs the computing result as carry signal c16.

AND-OR composite circuit 24_1 computes the OR of the AND of carry propagation signal p17 and carry signal C16, and carry generation signal g17, and it outputs the computing result as carry signal c17.

AND-OR composite circuit 24_2 computes the OR of the AND of carry propagation signal p18_16 and carry signal C15, and carry generation signal g18_16, and it outputs the computing result as carry signal c18.

AND-OR composite circuit 24_3 computes the OR of the AND of carry propagation signal p19 and carry signal C18, and carry generation signal g19, and it outputs the computing result as carry signal c19.

AND-OR composite circuit 24_4 computes the OR of the AND of carry propagation signal p20_16 and carry signal C15, and carry generation signal g20_16, and it outputs the computing result as carry signal c20.

AND-OR composite circuit 24_5 computes the OR of the AND of carry propagation signal p21 and carry signal C20, and carry generation signal g21, and it outputs the computing result as carry signal c21.

AND-OR composite circuit 24_j (where, j is an integer of 6 or 7) computes the OR of the AND of carry propagation signal p(16+j)_21 and carry signal C20, and carry generation signal g(16+j)_21, and it outputs the computing result as carry signal c(16+j).

AND-OR composite circuit 24_8 computes the OR of the AND of carry propagation signal p24_16 and carry signal C15, and carry generation signal g24_16, and it outputs the computing result as carry signal c24.

AND-OR composite circuit 24_9 computes the OR of the AND of carry propagation signal p25 and carry signal C24, and carry generation signal g25, and it outputs the computing result as carry signal c25.

AND-OR composite circuit 24_j (where, j is an integer of 10-13) computes the OR of the AND of carry propagation signal p(16+j)_25 and carry signal C24, and carry generation signal g(16+j)_25, and it outputs the computing result as carry signal c(16+j).

AND-OR composite circuit 24_14 computes the OR of the AND of carry propagation signal p30_16 and carry signal C15, and carry generation signal g30_16, and it outputs the computing result as carry signal c30.

Exclusive OR circuit 25_j (where, j is an integer of 0-14) computes the exclusive OR of carry signal c(15+j) and carry propagation signal p(16+j), and it outputs the computing result as sum signal s(16+j).

AND circuit 26_j (where, j is an integer of 0-14) computes the AND of input bit signals a(16+j) and b(16+j), and it outputs the computing result as carry generation signal g(16+j).

Exclusive OR circuit 27_j (where, j is an integer of 0-14) computes the exclusive OR of input bit signals a(16+j) and b(16+j), and it outputs the computing result as carry propagation signal p(16+j).

The above is an explanation of the various structural elements of CIA2.

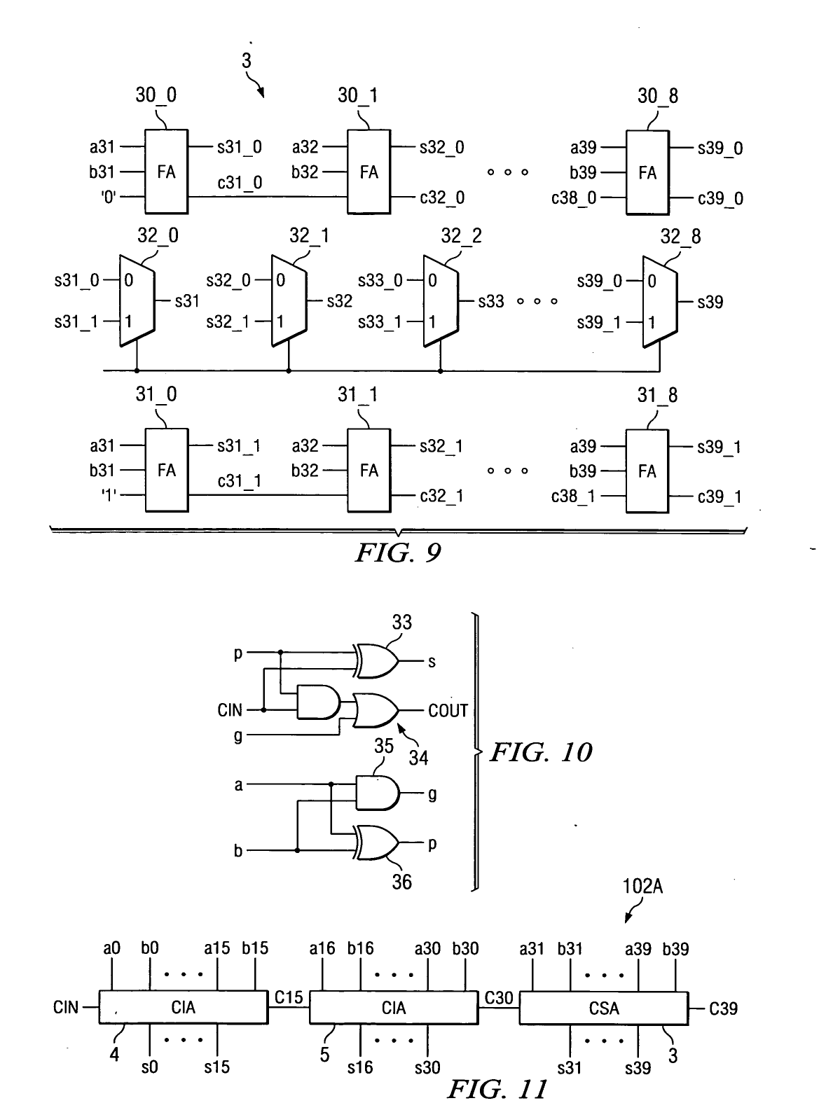

FIG. 9 is a block diagram illustrating an example of the constitution of CSA3.

For example, as shown in FIG. 9, CSA3 has full adders 30_0 . . . 30_8 and 31_0 . . . 31_8, and selectors 32_0 . . . 32_8.

In the following, the connection relationship of the various structural elements of CSA3 will be explained with reference to FIG. 9.

Full adder 30_0 has the bit signal of the 31^{st} place (a31, b31) input to it, and, if carry signal c30 is “0”, it computes sum signal s31_0 and carry signal c31_0 of the 31^{st} place.

Full adder 30_j (where, j is an integer of 1-8) has the bit signals of the (31 +j)th place, a(31+j) and b(31+j), input to it, and it also has carry signal c(30+j)_0 computed with former-step full adder 30_(j−1) input to it, and, corresponding to these input signals, it computes sum signal s(31 +j)_0 and carry signal c(31 +j)_0 of the (31 +j)th place.

Full adder 31_0 has the bit signals of the 31^{st} place (a31, b31) input to it, and, if carry signal c30 is “1”, it computes sum signal s31_1 and carry signal c31_1 of the 31^{st} place.

Full adder 31_j (where, j is an integer of 1-8) has the bit signals of the (31 +j)th place, a(31 +j) and b(31+j), input to it, and it also has carry signal c(30+j)_1 computed with former-step full adder 31_(j−1) input to it, and, corresponding to these input signals, it computes sum signal s(31 +j)_1 and carry signal c(31 +j)_1 of the (31 +j)th place.

FIG. 10 is a block diagram illustrating an example of the constitution of full adders 30_1, . . . 30_8, and 31_1, . . . 31_8.

For example, as shown in FIG. 10, said full adders each have AND circuit 35 for computing the AND of input bit signals a, b, exclusive OR circuit 36 for computing the exclusive OR of input bit signals a, b, exclusive OR circuit 33 for computing the exclusive OR of carry signal cin from the former place and carry propagation signal p output from exclusive OR circuit 36, and AND-OR composite circuit 34 for computing the OR of the AND of said carry signal cin and said carry propagation signal p, and carry generation signal g output from AND circuit 35. The computing result of exclusive OR circuit 33 becomes sum signal s, and the computing result of AND-OR composite circuit 34 becomes carry signal cout to the next place.

Also, full adder 30_0 and full adder 31_0 may be realized with the same circuit as that shown in FIG. 10. However, because carry signal cin from the former place can be taken as a fixed value, the circuit can be simplified.

For example, in full adder 30_0, one may delete exclusive OR circuit 33 and carry propagation signal p is output as sum signal s. Also, one may delete AND-OR composite circuit 34, and carry generation signal g is output as carry signal cout.

In full adder 31_1, one may substitute exclusive OR circuit 33 with a NOT circuit, and the NOT signal of signal p is output as sum signal s. Also, one may replace AND-OR composite circuit 34 with an OR circuit, and the OR of carry propagation signal p and carry generation signal g is output as carry signal cout.

Selector 32_j (where, j is an integer of 0-8) has sum signal s(31 +j)_0 and sum signal s(31 +j)_1 input to it, and it selects and outputs sum signal s(31 +j)_0 when carry signal c30 is _{—}“0”, and it selects and outputs sum signal s(31 +j)_1 when carry signal c30 is “1”. The output signal of selector 32_j becomes the sum signal s of the (31 +j)th digit.

The above is an explanation of the various structural elements of CSA3.

In the following, the operation of the multiplication circuit pertaining to this embodiment having the aforementioned constitution will be explained.

When multiplicand and multiplier signals D1 and D2 are given, partial product generating circuit 100 generates plural partial products p1-pX as shown in FIG. 16.

First addition circuit 101 performs addition of said partial products p1-pX, and generates two signals A and B. In this case, not all bits of the bit signals of signals A and B are generated at the same time. Instead, as shown in FIG. 2, they are generated with different delay times for the various bits, and they are input to second addition circuit 102. That is, the input timing to second addition circuit 102 is delayed in company with shift to the upper place in the lower bit range, it remains nearly constant in the intermediate bit range, and it is advanced in company with shift to the upper place in the upper bit range.

In the lower bit range (0^{th} place to 15^{th} place), addition is performed with the 1-level CIA1 shown in FIG. 4.

In 1-level CIA1, in the tandem circuit of AND circuits 10_1-10 _15, carry propagation signals p1_0-p15_0 are generated sequentially from the lower place, and, at the same time, in the tandem circuit of AND-OR composite circuits 12_1-12_15, carry generation signals g1_0-g15_0 are generated sequentially from the lower place. Then, based on said carry propagation signals p1_0-p15_0, carry generation signals g1_0-g15_0, and carry signal CIN to the 0^{th} place, carry signals c1-c15 of the various places are generated sequentially from the lower place.

Consequently, the trend of delay of said input timing of the signal from first addition circuit 101 in company with shift to the upper place is in agreement with the trend of delay of the computing timing of the addition values of the various places in company with shift to the upper place.

In the intermediate bit range (16^{th} place to 30^{th} place), addition is performed by means of 2-level CIA2 shown in FIGS. 5 and 6.

Said 2-level CIA2 as shown in FIG. 7 has two levels of generating circuits of the localized carry propagation signal and the carry generation signal.

That is, the localized carry propagation signal is generated in the following two steps: first carry propagation signal generating circuit (AND circuit 23_0, AND circuit 23_1, tandem circuit of AND circuits 23_2-23-4, and tandem circuit of AND circuits 23_5-23_9), and second carry propagation signal generating circuit (tandem circuit of AND circuits 22_0-22_3).

The localized carry generation signal is generated in the following two steps: first carry generation signal generating circuit (AND-OR composite circuit 21_0, AND-OR composite circuit 21_1, tandem circuit of AND-OR composite circuits 21_2-21_4, and tandem circuit of AND-OR composite circuits 21_5-21_9), and second carry generation signal generating circuit (tandem circuit of AND-OR composite circuits 20_0-20_3).

In the first step circuit (first carry propagation signal generating circuit, first carry generation signal generating circuit), the localized carry propagation signal and carry generation signal are generated based on the bit signals of the various places.

For example, the tandem circuit of AND circuits 23_5-23_9 directly generates carry generation signals g26_25-g30_25 based on carry propagation signals p25-p30 of the 25^{th} place to 30^{th} place.

In the second step circuit (second carry propagation signal generating circuit, second carry generation signal generating circuit), the signal output from the last step of the first step circuit is used to generate the localized carry propagation signal and carry generation signal.

For example, AND circuit 22_3 generates carry propagation signal p30_16 based on carry propagation signal p30_25 output from the last step of the tandem circuit of AND circuits 23_5-23_9, and carry propagation signal p24_16 output from former-step AND circuit 22_2.

If the circuits of only the first step are also taken as a tandem circuit, the same discussion can be made on AND circuits 22_0, 22_1, and AND-OR composite circuits 20_0, 20_1.

As explained above, the 2-level CIA2 has plural first-step circuits, and the localized carry propagation signal and carry generation signal are fed from said first-step circuits to the second-step circuits. Consequently, in the plural first-step circuits, generation of the localized carry propagation signals and carry generation signals is carried out in parallel. That is, the operations for generating carry generation signals g18_17, g20_19, g24_21, g30_25 are executed in parallel, and, at the same time, the operations for generating carry propagation signals p18_17, p20_19, p24_21, p30_25 are executed in parallel.

Consequently, compared with a 1-level CIA that generates all localized carry propagation signals and carry generation signals sequentially from the lower place, in this case, generation of the carry signal on the upper side has a higher speed. In other words, although the computing timing of the addition values of the various places is delayed in company with shift to the upper place, the trend of delay is milder than that of a 1-level CIA.

That is, compared with the lower bit range, in the intermediate bit range, the delay of the computing timing of the addition value on the upper side is smaller.

Also, in the upper bit range (31^{st} place to 39^{th} place), addition is performed with CSA3 shown in FIG. 9.

In CSA3, when carry signal c30 is “0” and when it is “1”, the predicted values of the carry signal and sum signal of the 31^{st} place to 39^{th} place are computed. Then, when carry signal c30 reaches CSA3, one of the pre-computed sum signals is selected with the selector, and it is output as the addition result. Consequently, if the predicted values are computed before the arrival of carry signal c30, delays from the arrival of carry signal c30 to generation of carry signals and sum signals of the various places are nearly the same.

That is, in the upper bit range, the delay in the timing for computing the addition value on the upper side is smaller than that in the lower and intermediate bit ranges.

As explained above, for second addition circuit 102 of this embodiment, in the lower bit range where the input timing of the bit signal delays in company with shift to the upper place, although the timing for computing the addition value on the upper side is slightly delayed with respect to the lower side, there is virtually no change in the output timing of the addition value. As a result, addition is performed with a 1-level CIA with a relatively low speed of propagation of carry to the upper side. In the intermediate bit range, where the input timing of the bit signal is nearly constant or a little advanced compared to that on the upper side, it is necessary to advance the timing in computing the addition value on the upper side with respect to the lower bit range. Consequently, addition is performed by means of a 2-level CIA having a carry propagation speed higher than that of the 1-level CIA. Also, in the upper bit range where the input timing of the bit signal is advanced in company with shift to the upper place, it is necessary to advance the timing for computing the addition value on the upper side as compared to the lower and intermediate bit ranges. Consequently, addition is performed by means of a CSA that can generate the upper addition value at a higher speed than the 1-level and 2-level CIAs.

In this way, matched to the trend of delay in the input timing of the bit signal in the various bit ranges, different addition schemes are adopted to perform the addition operation. Consequently, it is possible to perform the addition operation at high speed while the circuit scale and power consumption are reduced. For example, compared with the circuit scheme that has a carry look ahead circuit for increasing the speed of carry signal c30 to the upper bit range, it is possible to significantly reduce the circuit scale, and, at the same time, by using a 1-level CIA in the lower bit range and a 2-level CIA in the intermediate bit range, it is possible to realize a speed no lower than when a carry look ahead circuit is set.

Embodiment 2

In the following, Embodiment 2 will be explained.

In said Embodiment 1, 1-level and 2-level CIAs are used in performing addition of the intermediate bit range. In Embodiment 2, CIAs of other levels are used.

FIG. 11 is a block diagram illustrating an example of the constitution of second addition circuit 102A in Embodiment 2 of this invention.

Second addition circuit 102A is a 40-bit addition circuit that replaces second addition circuit 102 in the multiplication circuit shown in FIG. 1. For example, as shown in FIG. 11, it has CIA4 that performs addition in the low bit range (0^{th} place to 15^{th} place), CIA5 that performs addition in the intermediate bit range (16^{th} place to 30^{th} place), and CSA3 that performs addition in the upper bit range (31^{st} place to 39^{th} place).

CSA3 is the same as that shown in FIG. 9. Consequently, in the following, only CIA4 and CIA5 will be explained.

First of all, the kth carry propagation signal generating circuit and the kth carry generation signal generating circuit (where k is an integer of 2 or larger) are defined as follows.

The kth carry propagation signal generating circuit is a circuit containing plural circuits connected in tandem for generating carry propagation signal p(M2, M0) based on carry propagation signal pM2_M1 (where, M2 and M1 are positive integers with M2>M1) output from the last step of the tandem circuit of the (k−1)th carry propagation signal generating circuit, and carry propagation signal p(M1−1)_M0 (where, M0 is a positive integer with M1>M0) from the former step.

The kth carry generation signal generating circuit is a circuit containing plural circuits connected in tandem for generating carry generating signal gM2_M0 based on carry generation signal gM2_M1 output from the last step of the tandem circuit of the (k−1)th carry generation signal generating circuit, carry generation signal g(M1−1)_M0 from the former step, and carry propagation signal pM2-M1 output from the last step of the tandem circuit of the (k−1)th carry propagation signal generating circuit.

Consequently, the circuit of the kth step (the kth carry propagation signal generating circuit, the kth carry generation signal generating circuit) generate the localized carry propagation signal and the carry generation signal using the signal output from the last step of the circuit of the lower step(the (k−1)th step).

The m-level CIA (where, m is an integer of 1 or larger) is defined as follows using the aforementioned definitions.

The m-level CIA is a circuit containing the kth carry propagation signal generating circuit and the kth carry generation signal generating circuit with k up to m (m is an integer of 1 or larger).

With said definition, CIA4 and CIA5 of the lower and intermediate bit ranges are CIAs having different levels, and CIA5 is a CIA with a higher level than that of CIA4.

According to the aforementioned definition, for a CIA, as the number of localized carry generation signals and carry propagation signals generated in parallel in the rising order of level is increased, the speed carry propagation from the lower place to the upper place increases. Consequently, in this embodiment, too, just as in Embodiment 1, the carry propagation speed of the intermediate bit range is higher than that of the lower bit range, and the delay in the timing of computing of the addition value on the upper side decreases. Consequently, just as in Embodiment 1, it is possible to perform addition of the various bit ranges by means of addition schemes matched to the trend of delay of the input timing of the bit signal.

Also, if the trend of delay in the input timing of the bit signal in the lower and intermediate bit ranges is opposite that described above, CIA4 may be a CIA having a level higher than that of CIA5 as opposed to the aforementioned.

Embodiment 3

In the following, Embodiment 3 will be explained.

FIG. 12 is a block diagram illustrating an example of the constitution of second addition circuit 102B in Embodiment 3 of this invention.

Second addition circuit 102B is a 40-bit addition circuit that replaces second addition circuit 102 in the multiplication circuit shown in FIG. 1. For example, as shown in FIG. 12, it has ripple carry adder 6 for performing addition in the lower bit range (0^{th} place to 15^{th} place), CIA7 for performing addition in the intermediate bit range (16^{th} place to 30^{th} place), and CSA3 for performing addition in the upper bit range (31^{st} place to 39^{th} place). In the following, a ripple carry adder will be represented by RCA.

RCA6 is an embodiment of the fourth addition unit of this invention.

RCA6 computes the carry signals sequentially from the 0^{th} place to the 15^{th} place, and, using said computed carry signals, it computes a sum signal. For example, as shown in FIG. 13A, it has full adders 60_0, . . . 60_15 corresponding to the 0^{th} place, . . . the 15^{th} place, respectively.

Full adder 60_0 has the bit signals of the 0^{th} place (a0, b0) and carry signal CIN input to it, and, based on these signals, it computes sum signal s0 and carry signal c0 of the 0^{th} place.

Full adder 60_j (where, j is an integer of 1-15) has the bit signals of the jth place (aj, bj) input to it, and it also has carry signal c(j−1) computed with former-step full adder 60_(j−1) input to it, and, based on these input signals, it computes sum signal sj and carry signal cj.

The internal constitution of full adders 60_0 . . . 60_1 (FIG. 13B) is the same as that of the circuit shown in FIG. 10.

CIA7 is a CIA of any level, and it has a carry propagation speed higher than that of the RCA that generates the carry signal sequentially from the lower place.

In this embodiment, too, just as in Embodiment 1, compared with the lower bit range, the intermediate bit range has a higher carry propagation speed, and a smaller delay in the computing timing of the addition value on the upper side. Consequently, just as in Embodiment 1, it is possible to perform addition of the various bit ranges using addition schemes matched to the delay trend of the input timing of the bit signal. This embodiment, in particular, is effective when there is a large difference in delay of the computing time of the addition values between the lower side and the upper side in the lower bit range.

Embodiment 4

In the following, Embodiment 4 will be explained.

FIG. 14 is a block diagram illustrating an example of the constitution of second addition circuit 102C in Embodiment 4 of this invention.

Second addition circuit 102C is a 40-bit addition circuit that replaces second addition circuit 102 in the multiplication circuit shown in FIG. 1. For example, as shown in FIG. 14, it has CIA8 for performing addition in the lower bit range (0^{th} place to 15^{th} place), RCA9 for performing addition in the intermediate bit range (16^{th} place to 30^{th} place), and CSA3 for performing addition in the upper bit range (31^{st} place to 39^{th} place).

In this embodiment, compared with the lower bit range that performs addition with CIA8, the intermediate bit range that performs addition with RCA9 has a lower carry propagation speed, and a larger delay in timing of computing of the addition value on the upper side.

Consequently, this embodiment is appropriate for the case when the trend of delay of input timing of the upper side is more for the intermediate bit range than that for the lower bit range. For example, this embodiment is appropriate when the input timing of the bit signal in the lower bit range is constant, or when there is a trend of advance of said input timing in company with shift to the upper place or there is a trend of rapid increase in delay of the bit signal in company with shift to the upper place in the intermediate bit range.

Embodiment 5

In the following, Embodiment 5 will be explained.

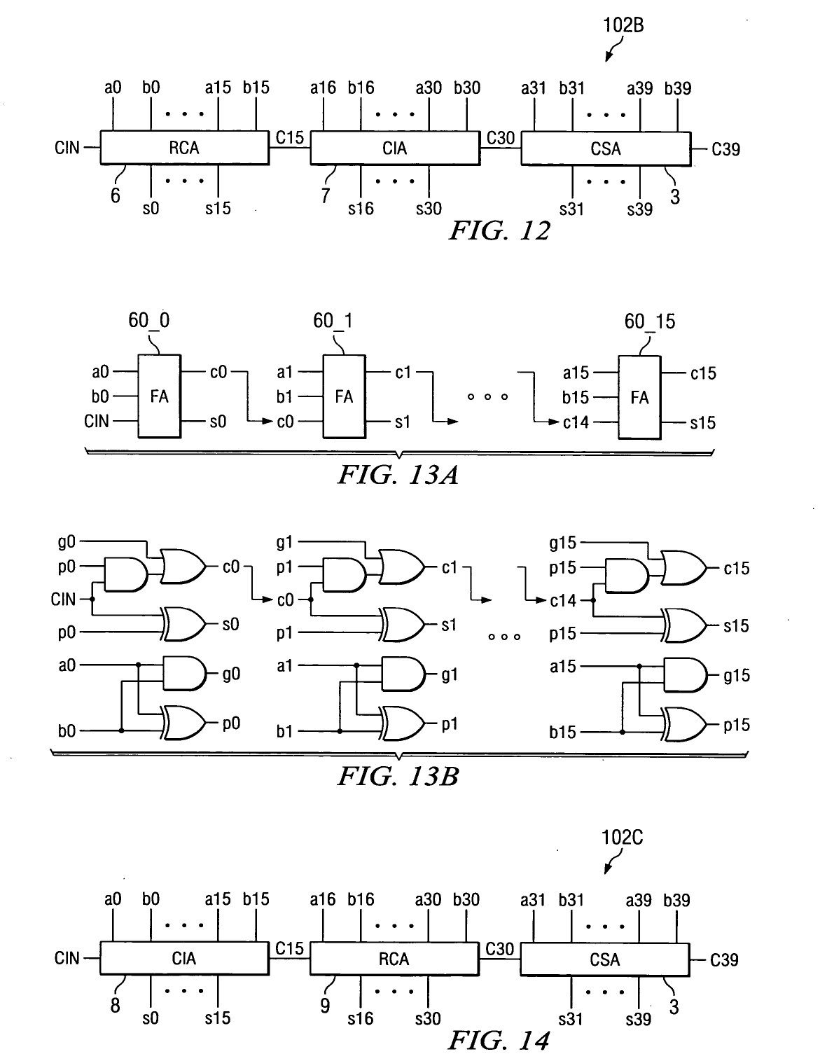

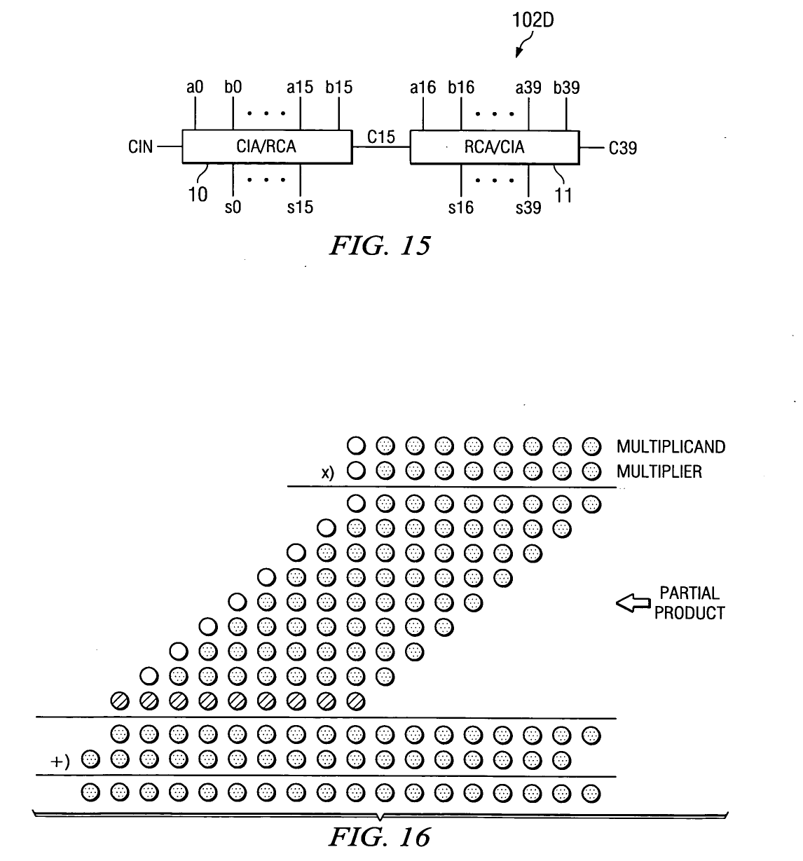

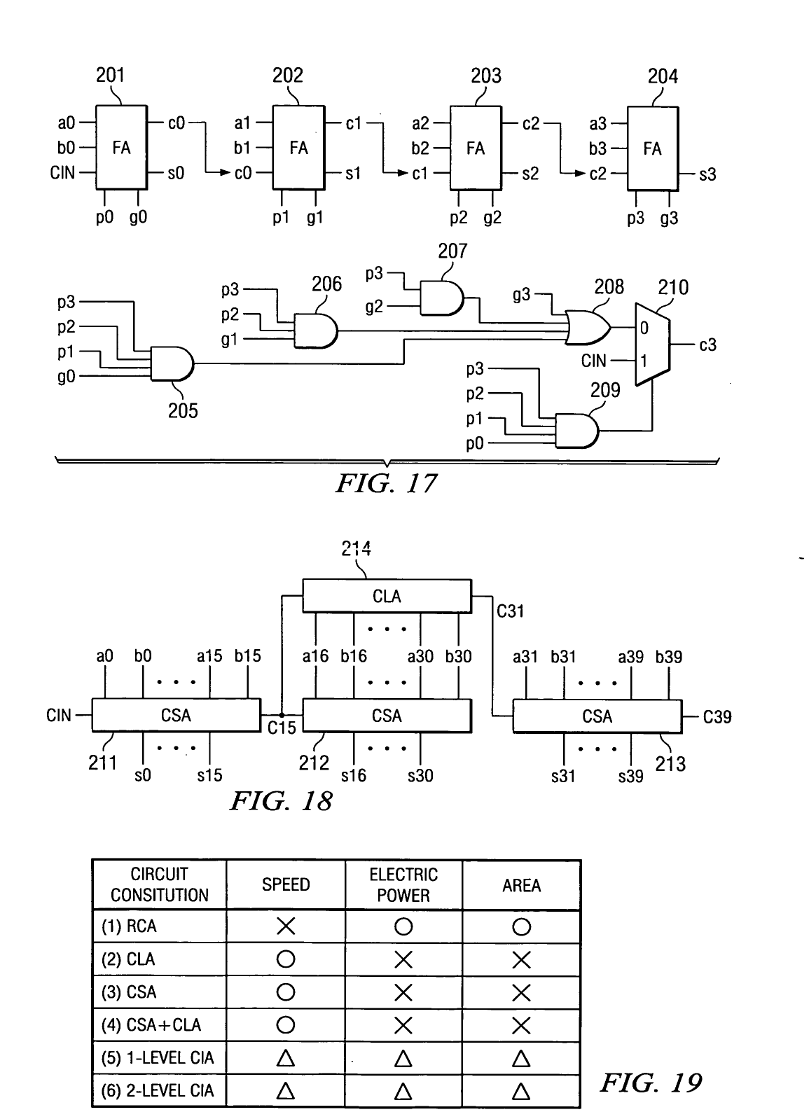

FIG. 15 is a block diagram illustrating an example of the constitution of second addition circuit 102D in Embodiment 5 of this invention.

Second addition circuit 102D is a 40-bit addition circuit that replaces second addition circuit 102 in the multiplication circuit shown in FIG. 1. For example, as shown in FIG. 15, it has addition unit 10 for performing addition in the lower bit range (0^{th} place to 15^{th} place), and addition unit 11 for performing addition in the upper bit range (16^{th} place to 39^{th} place).

Addition units 10 and 11 may have the constitution of either a CIA or RCA of any level. However, the two have different addition schemes.

In this embodiment, the CSA of the upper bit range placed in said Embodiments 1-4 is omitted. In place of it, a CIA or RCA addition unit is used. Consequently, the computing timing of the addition value in the upper bit range is delayed with respect to said Embodiments 1-4. Consequently, this embodiment is appropriate for the case in which in the upper bit range, the trend that the input timing of the upper side becomes advanced is relatively mild, and there is no need to compute the addition value at a speed as high as that of a CSA.

This invention is not limited to the aforementioned embodiments. Various modifications can be performed.

Usually, because the carry signal CIN input to the least significant place of the two signals added in the last step of the multiplication circuit is “0”, it is possible to use it to simplify the circuit in the lower bit range. For example, in CIA1 shown in FIG. 4, it is possible to omit AND-OR composite circuits 11_1-11_15, and to output carry generation signals g1_0-g15_0 as carry signals c1-c15, respectively.

Also, among the bit signals a0, b0 of the least significant place that are added in the last step of the multiplication circuit, usually, one is absent, that is, it is “0”. Consequently, this fact can also be exploited to simplify the circuit for the least significant place.

For example, when b0 is “0”, one may output bit signal a0 directly as sum signal s0 of the least significant place. Also, in this case, because the carry signal of the least significant place c0 is “0”, one may directly output carry propagation signal p1, that is, the exclusive OR of bit signals a1 and b1 of the first place, as sum signal s1 of the first place. By means of such simplification, in CIA1 shown in FIG. 4, it is possible to omit AND-OR composite circuit 11_0, exclusive OR circuits 13_0 and 13_1, AND circuit 14_0, and exclusive OR circuit 15_0.

Also, in the addition of the most significant place in the last step of the multiplication circuit, in order to perform code extension, usually, one of the two bit signals is inverted logically and added to the original signal, and the result is output as the sum signal. Consequently, by exploiting this feature, it is possible to also simplify the circuit for the most significant place.

For example, in CSA3 shown in FIG. 9, in full adders 30_8 and 31_8 of the most significant place, carry propagation signal p becomes “1”. Consequently, in both of these full adders, the following constitution may be adopted: exclusive OR circuit 33 shown in FIG. 10 is substituted with a NOT circuit, and the NOT of carry signal cin from the lower place is output as sum signal s.

The number of places and the bit ranges of the various signals in the aforementioned embodiments are merely examples. This invention is not limited to these examples. Also, the circuit constitutions explained in said embodiments are also merely examples for explanation, and one can freely change to other constitutions with the same function.

In FIGS. 3 and 4, a 1-level CIA is shown as an example of the carry increment adder 1. However, one may also adopt plural 1-level CIAs. For example, one may form carry increment adder 1 made of a tandem connection of a 1-level CIA with a 1-bit input, a 1-level CIA with a 2-bit input, a 1-level CIA with a 4-bit input, and a 1-level CIA with an 8-bit input to perform 16-bit computing. In this way, the 1-level CIA may also be realized with plural 1-level CIAs.

1. A type of addition circuit characterized by the following facts:
it has plural addition units that perform addition of different bit ranges of input signals of addition objects,
and at least two of said plural addition units perform addition by means of different addition schemes, which match the trend of change in the input timing of the bit signals of the addition objects in the bit range where addition is performed in company with shift to the upper place, with the difference in the trend of change of the computing timing of the addition value of each place in company with shift to the upper place.

2. The addition circuit described in claim 1 characterized by the fact that said plural addition units include:
a first addition unit that performs addition by means of a first addition scheme, which has said addition value computing timing delayed in company with shift to the upper place for the input signal in a first bit range having a trend that the input timing of the bit signal is delayed in company with shift to the upper place,
and a second addition unit that performs addition by means of a second addition scheme, which has said addition value computing timing delayed less than that of said first addition scheme in company with shift to the upper place for the input signal in a second bit range having a trend of delay of said input timing more or less than that in said first bit range.

3. The addition circuit described in claim 2 characterized by the fact that said first addition unit and said second addition unit each contain:
a first carry propagation signal generating circuit which has plural circuits connected in tandem and, based on carry propagation signal p(i−1, K) from the former step, generates carry propagation signal p(i, K) that indicates whether the carry signal generated at the ith place changes corresponding to the carry signal to the Kth place (where, K is a positive integer, and i is an integer, with i>K),
a first carry generation signal generating circuit, which has plural circuits connected in tandem and, based on carry generation signal g(i−1, K) from the former step, generates carry generation signal g(i, K) that indicates whether the carry signal generated at the ith place becomes a prescribed bit value independent of the carry signal to the Kth place,
and a carry signal generating circuit, which generates the carry signal generated at the ith place based on carry propagation signal p(i, K) output from said first carry propagation signal generating circuit, carry generation signal g(i, K) output from said first carry generation signal generating circuit, and the carry signal to the Kth place.

4. The addition circuit described in claim 3 characterized by the following facts:
the kth carry propagation signal generating circuit (where k is an integer of 2 or larger) is a circuit containing plural circuits connected in tandem and generating carry propagation signal p(M2, M0) based on carry propagation signal p(M2, M1) (where, M2 and M1 are positive integers with M2>M1) output from the last step of the tandem circuit of the (k−1)th carry propagation signal generating circuit, and carry propagation signal p(M1−1, M0) (where, M0 is a positive integer, with M1>M0) from the former step;
the kth carry generation signal generating circuit is a circuit containing plural circuits connected in tandem and generating carry generation signal g(M2, M0) based on carry generation signal g(M2, M1) output from the last step of the tandem circuit of the (k−1)th carry generation signal generating circuit, carry generation signal g(M1−1, M0) from the former step, and carry propagation signal p(M2, M1) output from the last step of the tandem circuit of the (k−1)th carry propagation signal generating circuit;
said first addition unit
contains a kth carry propagation signal generating circuit and a kth carry generation signal generating circuit with k up to m (where m is an integer of 1 or larger);
said second addition unit
contains a kth carry propagation signal generating circuit and a kth carry generation signal generating circuit with k up to n (where n is an integer larger than m).

5. The addition circuit described in any of claim 1 characterized by the fact that said plural addition units each have a third addition unit, which, with respect to the input signal of the bit range having a trend of advance of said input timing in company with shift to the upper place, pre-computes prediction values of the carry signals of the various places corresponding to the assumed values of the carry signals from the lower places fed to said bit range, respectively, and which performs addition using a third addition scheme that generates the carry signals of the various places based on the carry signals fed from said lower places and said predicted values.

6. The addition circuit described in any of claim 1 characterized by the fact that said plural addition units each have a fourth addition unit, which performs addition using a fourth addition scheme that sequentially computes the carry signals from the lower place to the upper place with respect to the input signal of the bit range having a trend of delay of said input timing in company with shift to the upper place.

7. A type of multiplication circuit characterized by the following facts:
the multiplication circuit has a first addition circuit that outputs two signals as the result of addition of more than two plural partial products, and a second addition circuit that adds the two signals output from said first addition circuit; and
said second addition circuit is the addition circuit described in any of claim 1 and having plural addition units that perform addition of the different bit ranges of the two signals output from said first addition circuit, respectively.

8. The multiplication circuit described in claim 7 characterized by the fact that said second addition circuit contains:
the first addition unit described in claim 4 that performs addition of said two signals for the bit range from the least significant place to a prescribed intermediate place,
the second addition unit described in claim 4 that performs addition of said two signals for the bit range from said intermediate place to a prescribed upper place,
and the third addition unit described in claim 5 that performs addition of said two signals for the bit range from said upper place to the most significant place.

9. The multiplication circuit described in claim 7 characterized by the fact that said second addition circuit outputs the bit signal of the least significant place of one of said two signals as the result of addition of the least significant place, and, at the same time, it outputs an exclusive OR of the bit signals of the upper place as the result of addition of the upper place of said least significant place.

10. The multiplication circuit described in any of claims 7-9 characterized by the fact that said second addition circuit outputs a NOT signal of the carry signal from the lower place to the most significant place as the result of addition of the most significant place.

11. The multiplication circuit described in any of claim 7 characterized by the fact that said first addition circuit contains plural full adders connected in a tree configuration.

12. A type of multiplication/addition circuit characterized by the following facts:
the multiplication/addition circuit has a first addition circuit that outputs two signals as the result of addition of more than two plural partial products, and a second addition circuit that performs addition of the two signals output from said first addition circuit;
said second addition circuit is the addition circuit described in any of claim 1 having plural addition units that perform addition of the different bit ranges of the two signals output from said first addition circuit, respectively.

13. The multiplication/addition circuit described in claim 12 characterized by the fact that said second addition circuit contains:
the first addition unit described in claim 4 that performs addition of said two signals for the bit range from the least significant place to a prescribed intermediate place,
the second addition unit described in claim 4 that performs addition of said two signals for the bit range from said intermediate place to a prescribed upper place,
and the third addition unit described in claim 5 that performs addition of said two signals for the bit range from said upper place to the most significant place.
